(19) United States
(12) Patent Application Publication
(10) Pub. No.: US 2025/0278226 A1
(43) Pub. Date: Sep. 4, 2025

(54) IMAGE PROCESSING SYSTEM, IMAGE PROCESSING METHOD, AND NON-TRANSITORY COMPUTER READABLE MEDIUM

(71) Applicant: FUJIFILM Business Innovation Corp., Tokyo (JP)

(72) Inventor: Yoshinobu NAKAMURA, Yokohama-shi (JP)

(73) Assignee: FUJIFILM Business Innovation Corp., Tokyo (JP)

(21) Appl. No.: 18/761,874

(22) Filed: Jul. 2, 2024

(30) Foreign Application Priority Data
Mar. 1, 2024 (JP) 2024-031545

(51) Int. Cl. G06F 3/12

(52) U.S. Cl. CPC G06F 3/1243; G06F 3/1208; G06F 3/1256

(57) ABSTRACT

An image processing system includes a processor configured to: accept document data to be printed and multiple pieces of additional data each including a shared image to be used across multiple pages; for each piece of the multiple pieces of additional data, select a corresponding rendering application in accordance with an attribute of the piece of the multiple pieces of additional data; perform a rendering process using the selected rendering application; and generate image data to be used for image formation by superimposing data obtained through the rendering process onto data obtained through a rendering process for the document data to be printed.

### CROSS-REFERENCE TO RELATED APPLICATIONS

This application is based on and claims priority under 35 USC 119 from Japanese Patent Application No. 2024-031545 filed Mar. 1, 2024.

### BACKGROUND

### (i) Technical Field

The present disclosure relates to an image processing system, an image processing method, and a non-transitory computer readable medium.

### (ii) Related Art

Japanese Unexamined Patent Application Publication No. 2010-005793 discloses an image forming system configured to use different rendering methods for print information and preregistered information such as a form and perform parallel rendering processes.

### SUMMARY

In image processing systems for commercial printing, document data contained in a printing-process request called a print job is accompanied by additional data called part data added to the document data, and the document data and the additional data are entered into image processing systems. The document data and the additional data are subjected to a rendering process for conversion to a raster image, and an image is formed on an image formation medium such as paper. Examples of part data include a page number, a form, a watermark, a color patch, and a comment, which are supplementarily added to the document data. The above rendering process is also referred to as rasterization processing or raster image processing (RIP).

When these types of additional data are rendered, a prespecified rendering application called a decomposer or the same rendering application as is used to render the document data contained in the printing-process request has been used. However, the complexity of additional data gradually increases, and the number of pieces of additional data that specify a transparency effect or a custom color also increases. Since the complexity of additional data differs from one piece of additional data to another, using the same rendering application for all of the additional data has caused the inconvenience of being unable to obtain a print result that matches a user's intention.

Aspects of non-limiting embodiments of the present disclosure relate to providing an image processing system, an image processing method, and a non-transitory computer readable medium that enable image formation that reflects an attribute of additional data without relying on a user's instruction on the selection of a rendering application.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image processing system comprising:
a processor configured to:
   accept document data to be printed and a plurality of pieces of additional data each including a shared image to be used across a plurality of pages;
   for each piece of the plurality of pieces of additional data,
      select a corresponding rendering application in accordance with an attribute of the piece of the plurality of pieces of additional data;
      perform a rendering process using the selected rendering application; and
      generate image data to be used for image formation by superimposing data obtained through the rendering process onto data obtained through a rendering process for the document data to be printed.

### BRIEF DESCRIPTION OF THE DRAWINGS

An exemplary embodiment of the present disclosure will be described in detail based on the following figures, wherein:

FIG. 1 is an illustration depicting an example of a configuration of an image processing system according to the exemplary embodiment;

FIG. 2 is an illustration depicting a hardware configuration of an image processing apparatus according to the exemplary embodiment;

FIG. 3 is a block diagram depicting a functional configuration of the image processing apparatus according to the exemplary embodiment;

FIG. 4 is a flowchart depicting an example of a process performed by a job controller to select a candidate for the rendering application to perform a rendering process;

FIG. 5 is a flowchart depicting an example of a process performed by the job controller after performing the process in FIG. 4;

FIG. 6 is an illustration depicting an example of a rendering-process setting screen;

FIG. 7 depicts an example of a setting screen for establishing a threshold to select a rendering application;

FIG. 8 is a flowchart depicting an example of a process according to Modification 1 for selecting a candidate for the rendering application to perform a rendering process after a threshold is established;

FIG. 9 is an illustration depicting an example of a rendering-process setting screen according to Modification 2;

FIG. 10 is an illustration depicting an example of a rendered-result display screen according to Modification 2; and

FIG. 11 is a block diagram depicting a functional configuration of an image processing apparatus according to Modification 3.

### DETAILED DESCRIPTION

### Exemplary Embodiment

An exemplary embodiment of the present disclosure will be described in detail with reference to the drawings.

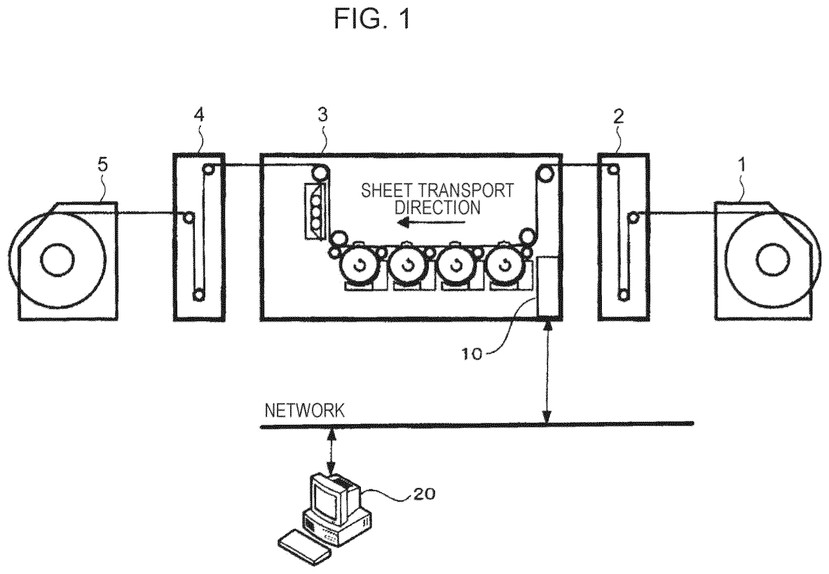

FIG. 1 is an illustration depicting an example of a configuration of an image processing system according to the exemplary embodiment of the present disclosure. As depicted in FIG. 1, the image processing system according to the exemplary embodiment includes a preprocessing apparatus 1, a buffer 2, a printer 3 configured to perform printing on continuous paper, a buffer 4, a postprocessing apparatus 5, a controller 10, and a terminal apparatus 20.

The preprocessing apparatus 1 is configured to store unprinted continuous paper wound into a roll and perform preprocessing of sending the unprinted continuous paper to the printer 3. The postprocessing apparatus 5 is configured to perform postprocessing of receiving printed continuous paper sent from the printer 3 and winding the printed continuous paper into a roll. The buffers 2 and 4 are disposed to absorb the differences in the transport speed of the continuous paper between the preprocessing apparatus 1 and the printer 3 and between the postprocessing apparatus 5 and the printer 3, respectively, and are configured to hold the continuous paper to keep the tension of the continuous paper constant therebetween.

The terminal apparatus 20 is configured to create document data to be contained in a printing-process request called a print job and additional data to be added to the document data and transmit the document data and the additional data to the controller 10 via a network. The additional data contains multiple pieces of part data, which will be described below.

The controller 10 is also referred to as a digital front end and is configured to control the printer 3 and perform data processing for the data entered into the printer 3. Specifically, the controller 10 is configured to control the printing operation of the printer 3 based on a print job sent from the terminal apparatus 20 that contains the document data and the additional data and apply image processing to the document data and the additional data sent from the terminal apparatus 20. The printer 3 is subjected to the control by the controller 10 and is configured to form an image on the continuous paper in accordance with print data obtained through the image processing in the controller 10.

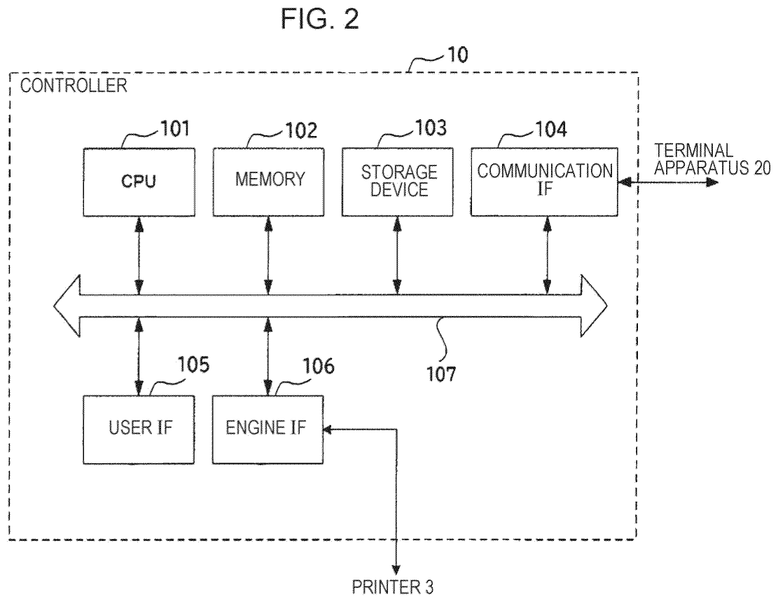

Next, a hardware configuration of the controller 10 according to the present exemplary embodiment will be described with reference to FIG. 2. As depicted in FIG. 2, the controller 10 includes a central processing unit (CPU) 101, a memory 102, and a storage device 103 such as a hard disk drive. The controller 10 further includes a communication interface (IF) 104 configured to transmit and receive data to and from the terminal apparatus 20 via the network, a user IF 105 including a touch panel and a liquid crystal display, and an engine IF 106 configured to transmit and receive data to and from the printer 3. These constituent elements are connected to each other by using a control bus 107.

The CPU 101 is configured to perform a predetermined process based on a control program stored in the memory 102 or the storage device 103 and control the operation of the controller 10. The control program may be provided to the CPU 101 in a stored form by using a portable recording medium, such as a universal-serial-bus (USB) memory.

The memory 102 and the storage device 103 store the control program to operate the controller 10, which will be described below. The control program may be provided in a stored form by using a portable medium, such as a USB memory as described above, instead of using the memory 102 or the storage device 103.

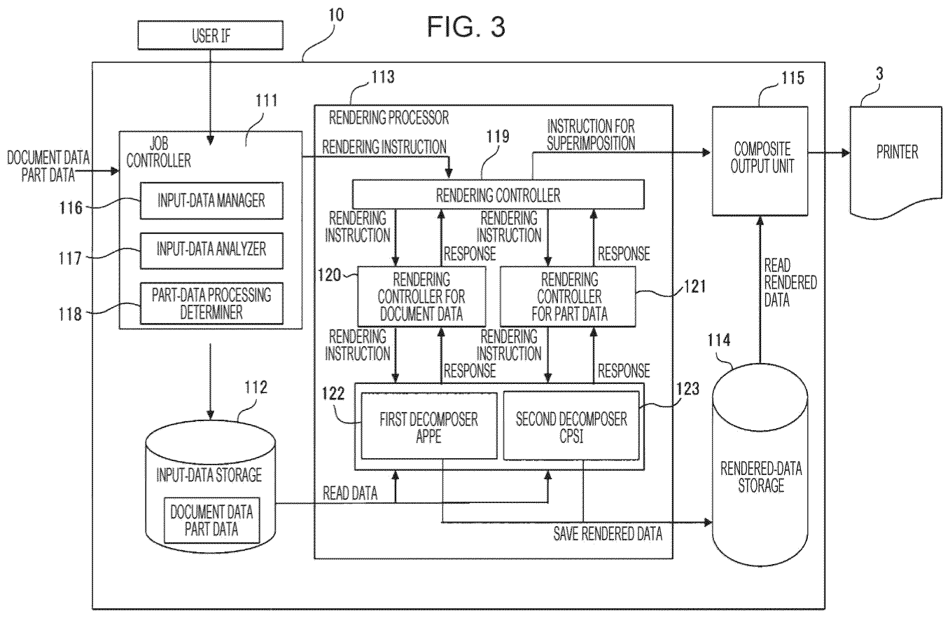

FIG. 3 is a block diagram depicting a functional configuration of the controller 10 implemented by the execution of the above control program in the CPU 101.

As depicted in FIG. 3, the controller 10 includes a job controller 111, an input-data storage 112, a rendering processor 113, a rendered-data storage 114, and a composite output unit 115.

The job controller 111 is configured to receive document data and multiple pieces of additional data called part data contained in a print job entered into the controller 10, perform preprocessing, and subsequently instructs the rendering processor 113 to perform a rendering process. The job controller 111 further includes an input-data manager 116, an input-data analyzer 117, and a part-data processing determiner 118 as components for performing preprocessing.

The input-data manager 116 is configured to receive a print job entered into the controller 10. The print job includes document data to be printed and multiple pieces of additional data called part data. The document data provides information on a page-by-page basis and includes data across multiple pages. Examples of part data may include a page number, a form, a watermark, a color patch, and a comment, which are shared data, that is, a shared image to be used across multiple pages. The part data may include a shared image to be used across all the pages or may include either an image or a piece of data that differs from page to page.

The input-data manager 116 is configured to assign a job ID to a group consisting of the document data and multiple pieces of additional data contained in the print job and save the document data and the multiple pieces of additional data to the input-data storage 112 in association with the setting information.

The input-data analyzer 117 is configured to analyze the print job saved to the input- data storage 112. Specifically, the input-data analyzer 117 is configured to analyze the document data and the additional data contained in the print job and extract information such as the data type, the page size, and the color space and attribute information such as the font, the transparency effect, and the custom-color specification.

The part-data processing determiner 118 is configured to use the analysis result obtained by the input-data analyzer 117 and, for each piece of the multiple pieces of additional data called part data, select a candidate for the rendering application to perform a rendering process in accordance with the attribute and the data type of the piece of part data. Information regarding the selected candidate for the rendering application is saved to the input-data storage 112 in association with the piece of part data. For example, the part-data processing determiner 118 selects a first decomposer 122, which is a first rendering application, as a candidate for the rendering application if the data type of a piece of part data is the PDF format and the piece of part data includes either the transparency effect or the custom-color specification as an attribute. For example, the first decomposer 122 is Adobe PDF print engine (APPE), which supports objects including the transparency effect or the custom-color specification. In contrast, the part-data processing determiner 118 selects a second decomposer 123, which is a second rendering application, as a candidate for the rendering application if the data type of a piece of additional data is a specific page description language format such as the PostScript (registered trademark) format. The second decomposer 123 is, for example, Configurable PostScript interpreter (CPSI).

The input-data storage 112 is configured to store the document data and the multiple pieces of part data contained in the print job entered by the input-data manager 116 as described above. Each piece of document and part data is assigned a corresponding job ID, and each piece of part data is stored in association with the information regarding the candidate for the rendering application selected by the part-data processing determiner 118.

The rendering processor 113 is configured to perform a rendering process for the document data and the part data contained in the print job. The rendering processor 113 includes a rendering controller 119, a rendering controller for document data 120, a rendering controller for part data 121, the first decomposer 122, and the second decomposer 123.

The rendering controller 119 is configured to separate a rendering instruction received from the job controller 111 into a rendering instruction for the document data and a rendering instruction for the part data and send respective instructions to the rendering controller for document data 120 and the rendering controller for part data 121. Specifically, the rendering controller 119 is configured to instruct the rendering controller for document data 120 to perform a rendering process for the document data. In addition, the rendering controller 119 is configured to instruct the rendering controller for part data 121 to perform a rendering process for each piece of part data using the designated rendering application.

The rendering controller for document data 120 is configured to activate and deactivate the first decomposer 122 and the second decomposer 123 and perform switching between the first decomposer 122 and the second decomposer 123 in accordance with the rendering instruction received from the rendering controller 119.

The rendering controller for part data 121 is configured to activate and deactivate the first decomposer 122 and the second decomposer 123 and perform switching between the first decomposer 122 and the second decomposer 123 in accordance with the instruction received from the rendering controller 119.

The first decomposer 122 is configured to perform a rendering process on a page-by-page basis in accordance with instructions from the rendering controller for document data 120 and the rendering controller for part data 121. The first decomposer 122 is, for example, APPE as described above. Specifically, the first decomposer 122 is configured to convert data in the PDF format and part data including the transparency effect or the custom-color specification as the attribute into raster-format image data by applying interpreter processing and rasterization processing.

The second decomposer 123 is configured to perform a rendering process on a page-by-page basis in accordance with instructions from the rendering controller for document data 120 and the rendering controller for part data 121. The second decomposer 123 is, for example, CPSI as described above. Specifically, the second decomposer 123 is configured to convert document data and part data expressed in a specific page description language format such as the PostScript format into raster-format image data by applying interpreter processing and rasterization processing.

In a raster format, an image is divided into numerous small dots, that is, pixels arranged in a grid pattern, and raster-format image data expresses such an image using numerical value sets each representing the color and density of a dot in a color system such as RGB or CMYK.

Data obtained by the conversion into a raster format through the rendering processes by the first decomposer 122 and the second decomposer 123 is saved to the rendered-data storage 114 as rendered document data and rendered part data.

The composite output unit 115 is configured to superimpose the data obtained through the rendering process for each piece of part data onto the data obtained through the rendering process for the document data to be printed and generate image data to enable image formation. Specifically, the composite output unit 115 is configured to read and composite the rendered document data and the rendered part data stored in the rendered-data storage 114 to create final data consisting of a grid of dots and output print data to the printer 3 via the engine IF 106.

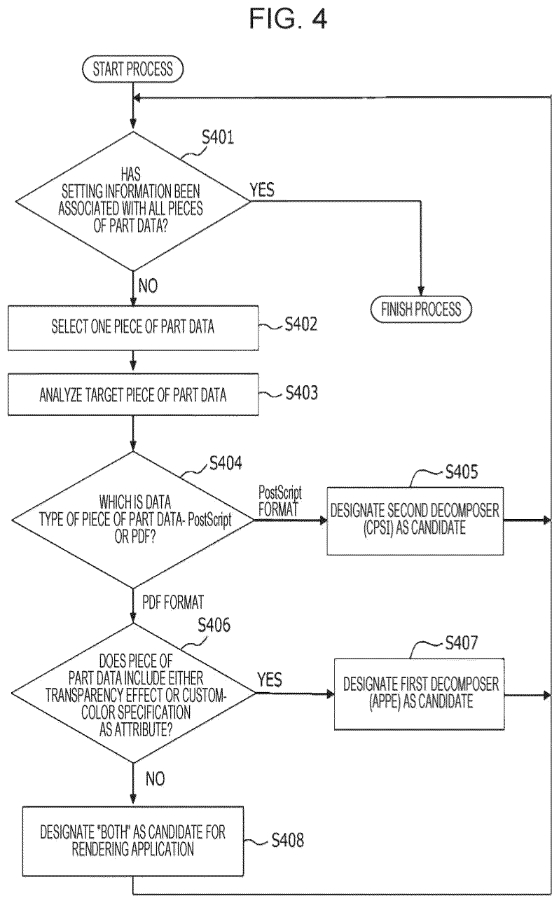

Next, referring to FIG. 4 to FIG. 6, description will be given with regard to a method of selecting a candidate for the rendering application to perform a rendering process in the job controller 111. The input-data manager 116 is configured to, in response to receiving document data and additional data contained in a print job, first assign a job ID to a group consisting of the document data and multiple pieces of part data contained in the additional data. The input-data storage 112 is configured to then save the document data contained in the print job.

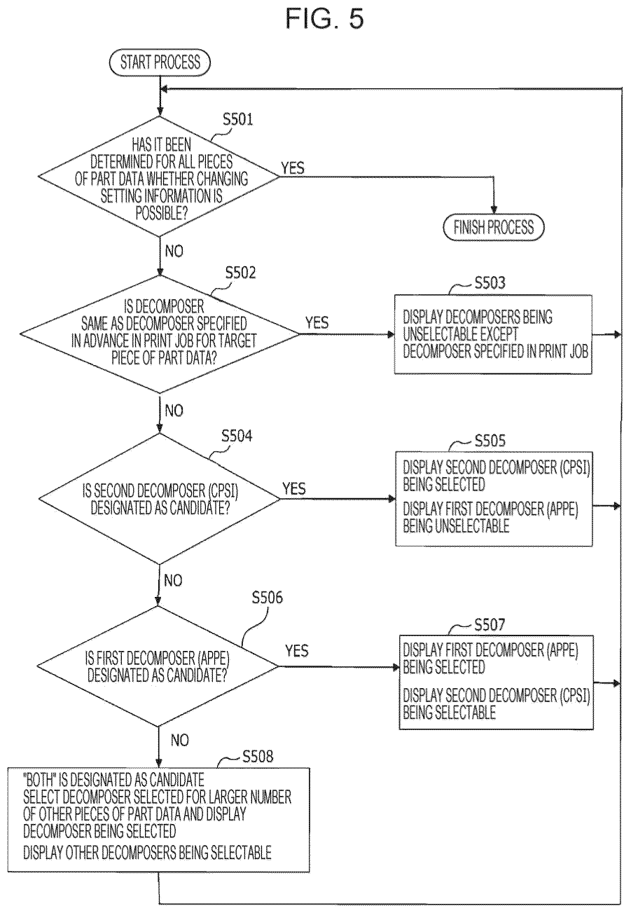

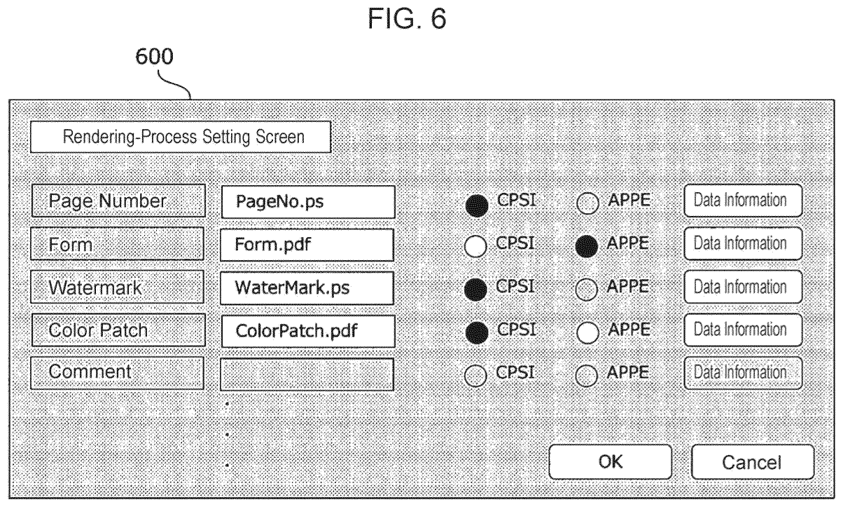

In step S401 in FIG. 4, the input-data manager 116 determines whether setting information containing information regarding a candidate for the rendering application has been associated with all the multiple pieces of part data contained in a print job. If setting information is associated with all the pieces of part data assigned the same job ID, the job controller 111 finishes the process and displays a rendering-process setting screen in FIG. 6 after further performing the process in FIG. 5. If it is determined that setting information is not associated with one or more pieces of part data, the process proceeds to step S402.

In step S402, the input-data manager 116 selects one of the multiple pieces of part data, and the process proceeds to step S403 and later described below.

In step S403, the input-data analyzer 117 analyzes a target piece of part data selected in step S402 and extracts data information including information such as the data type, the page size, and the color space, the font, the presence of the transparency effect, and the presence of the custom-color specification. The data type of part data indicates the type of page description language such as the PostScript format or the PDF format.

In step S404, the part-data processing determiner 118 uses the analysis result obtained by the input-data analyzer 117 and determines the data type of the piece of part data. Specifically, if the data type of the piece of part data is the PostScript format, the process proceeds to step S405.

In step S405, as setting information, the part-data processing determiner 118 designates the second decomposer 123 as a candidate for the rendering application to perform a rendering process for the target piece of part data and saves the setting information to the input-data storage 112 in association with the target piece of part data. The second decomposer 123 is CPSI in the present exemplary embodiment. Subsequently, the process returns to step S401.

If it is determined in step S404 that the data type of the piece of part data is the PDF format, the process proceeds to step S406.

In step S406, the part-data processing determiner 118 uses the analysis result obtained by the input-data analyzer 117 and determines the attribute of the piece of part data. The attribute of the piece of part data indicates data information except the data type. In the present exemplary embodiment, it is determined whether an object included in the target piece of part data includes either the transparency effect or the custom-color specification as the attribute of the target piece of part data, and if the object includes either the transparency effect or the custom-color specification as the attribute, the process proceeds to step S407.

In step S407, as setting information, the part-data processing determiner 118 designates the first decomposer 122 as a candidate for the rendering application to perform a rendering process for the target piece of part data and saves the setting information to the input-data storage 112 in association with the target piece of part data. The first decomposer 122 is APPE in the present exemplary embodiment. Subsequently, the process returns to step S401.

If it is determined in step S406 that no object included in the target piece of part data includes the transparency effect or the custom-color specification, the process proceeds to step S408. In summary, if the piece of part data includes neither the transparency effect nor the custom-color specification as an attribute and the data type is not the PostScript format, the process proceeds to step S408.

In step S408, as setting information, the part-data processing determiner 118 designates “BOTH” as a candidate for the rendering application to perform a rendering process for the target piece of part data and saves the setting information to the input-data storage 112 in association with the target piece of part data. The setting information “BOTH” indicates that the first decomposer 122 and the second decomposer 123 both may perform the rendering process. Subsequently, the process returns to step S401.

In step S401, the input-data manager 116 determines whether information regarding a candidate for the rendering application has been associated with all the multiple pieces of part data, and upon determining that the information has been associated with all the multiple pieces of part data, the input-data manager 116 further performs the process in FIG. 5 and then displays the rendering-process setting screen in FIG. 6.

In step S501 in FIG. 5, the part-data processing determiner 118 determines whether it has been determined for all the multiple pieces of part data assigned the same job ID whether changing the setting information is possible. If the setting information has not been changed for one or more of the multiple pieces of part data, the process proceeds to step S502.

In step S502, one of the pieces of part data is selected as a target piece of part data, and it is determined whether the rendering application to perform a rendering process for the target piece of part data is the same as the rendering application specified in advance in the data information contained in the print job. If the rendering application to perform a rendering process is the same as the rendering application specified in advance in the print job, the process proceeds to step S503.

In step S503, the job controller 111 displays the prespecified rendering application being selected for the target piece of part data. The job controller 111 displays other rendering applications being unselectable in the rendering-process setting screen, and the process returns to step S501.

Specifically, FIG. 6 depicts an example of a rendering-process setting screen 600 displayed by the user IF 105. First, the rendering-process setting screen 600 is a confirmation screen configured to, for each piece of part data contained in a print job, display a selected candidate for the rendering application and ask a user for confirmation. Specifically, the rendering-process setting screen 600 displays a list of the pieces of part data contained in a print job stored in the input-data storage 112 in association with the filename of each piece of part data and a candidate for the rendering application designated for each piece of part data.

This example indicates that the filename of a piece of part data named “Page Number” is “PageNo.ps”, and the data type is the PostScript format. The selected candidate for the rendering application is CPSI. As described above, since the rendering application for the piece of part data “Page Number” has been specified in advance in the data information in the print job, the radio button for APPE is displayed in the unselectable condition to prevent the user from redesignating APPE as a candidate for the rendering application.

If it is determined in step S502 that the rendering application to perform the rendering process has not been specified in advance in the data information in the print job, the process proceeds to step S504.

In step S504, the setting information regarding the target piece of part data is referred to, and it is determined whether CPSI is designated as a candidate for the rendering application to perform the rendering process. If CPSI is designated, the process proceeds to step S505.

In step S505, the job controller 111 displays CPSI being selected as a candidate for the rendering application to perform the rendering process for the target piece of part data. The job controller 111 displays other rendering applications being unselectable in the rendering-process setting screen 600, and the process returns to step S501.

Specifically, FIG. 6 indicates that, for example, the filename of a piece of part data named “Watermark” is “WaterMark.ps”, indicating the data type being the PostScript format, and CPSI is selected as a candidate for the rendering application. The radio button for APPE is displayed in the unselectable condition to prevent the user from redesignating APPE as a candidate for the rendering application.

If it is determined in step S504 that CPSI is not designated as a candidate for the rendering application to perform the rendering process for the target piece of part data, the process proceeds to step S506.

In step S506, the setting information regarding the target piece of part data is referred to, and it is determined whether APPE is designated as a candidate for the rendering application to perform the rendering process. If APPE is designated, the process proceeds to step S507.

In step S507, the job controller 111 displays APPE being selected as a candidate for the rendering application to perform the rendering process for the target piece of part data. The job controller 111 displays other rendering applications being reselectable in the rendering-process setting screen 600, and the process returns to step S501.

Specifically, FIG. 6 indicates that, for example, the filename of a piece of part data named “Form” is “Form.pdf”, indicating the data type being the pdf format, and APPE is selected as a candidate for the rendering application. The radio button for CPSI is displayed in the selectable condition to allow the user to redesignate CPSI as a candidate for the rendering application.

If it is determined in step S506 that APPE is not designated as a candidate for the rendering application to perform the rendering process for the target piece of part data, the process proceeds to step S508.

In step S508, the job controller 111 assumes that “BOTH” is designated as a candidate for the rendering application to perform the rendering process for the target piece of part data and performs the following processes. Specifically, for the piece of part data for which “BOTH” is designated as a candidate for the rendering application, the job controller 111 selects a rendering application that has been selected for a larger number of other pieces of part data and displays the rendering application being selected. Rendering applications that have not been selected are displayed in the reselectable condition in the rendering-process setting screen 600, and the process returns to step S501.

Specifically, FIG. 6 indicates that, for example, the filename of a piece of part data named “Color Patch” is “ColorPatch.pdf”, indicating the data type being the pdf format, and CPSI is selected as a candidate for the rendering application. This is because CPSI has been selected as the rendering application for a larger number of other pieces of part data. The radio button for APPE is displayed in the selectable condition to allow the user to redesignate APPE as a candidate for the rendering application.

In the present example, it is assumed that the user has selected a candidate for the rendering application for each piece of part data in the rendering-process setting screen 600 in FIG. 6 and has selected the “OK” button. Then, the rendering controller 119 instructs the rendering controller for part data 121 to perform a rendering process for each piece of part data using the rendering application that has been designated.

Specifically, in the setting condition depicted in FIG. 6, the rendering controller 119 provides instructions to perform rendering processes for the pieces of part data “Page Number”, “Watermark”, and “Color Patch” using CPSI as the rendering application. In contrast, the rendering controller 119 provides an instruction to perform a rendering process for the piece of part data “Form” using APPE as the rendering application. The rendering controller 119 provides instructions to consecutively perform rendering processes for pieces of part data designated the same rendering application. Namely, the rendering controller 119 provides instructions to consecutively perform rendering processes using the same rendering application, CPSI, for the pieces of part data “Page Number”, “Watermark”, and “Color Patch”. This procedure makes it avoidable to activate and deactivate rendering applications to switch between the rendering applications every time a rendering process starts for a piece of part data.

In general, since a decomposer uses hardware resources including a relatively-large-sized memory, activating or deactivating the decomposer takes time. The above procedure may keep the number of times of switching between the rendering applications as low as possible.

The rendering controller for document data 120 activates and deactivates the first decomposer 122 and the second decomposer 123 and performs switching between the first decomposer 122 and the second decomposer 123 in accordance with a rendering instruction received from the rendering controller 119, and the rendering controller for document data 120 performs a rendering process for part data in this way. Data obtained by the conversion into a raster format through rendering processes by the first decomposer 122 and the second decomposer 123 is saved to the rendered-data storage 114 as rendered part data.

Then, the composite output unit 115 composites the rendered document data and the rendered part data stored in the rendered-data storage 114 to create final data formed by a grid of dots and outputs print data to the printer 3 via the engine IF 106.

### Modification 1

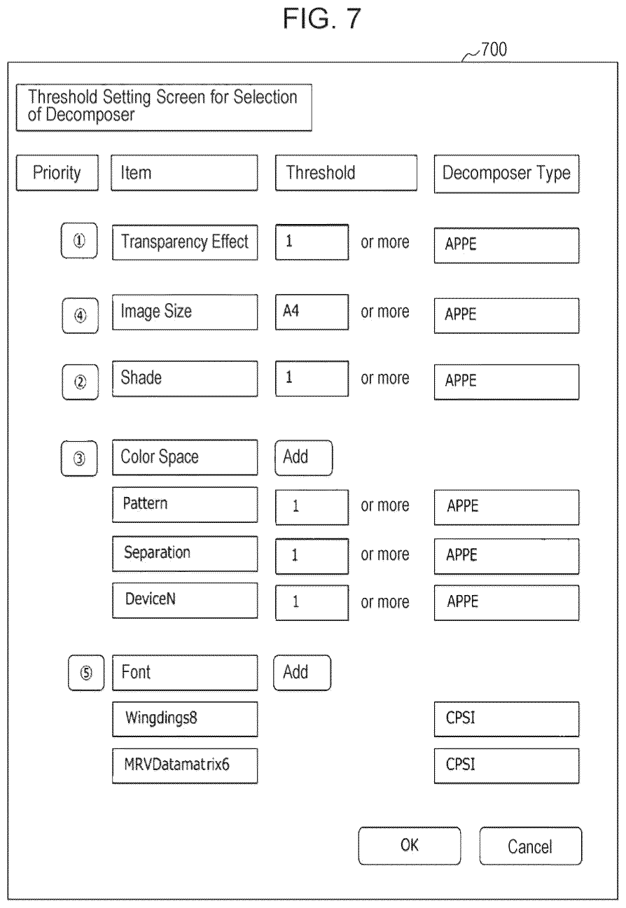

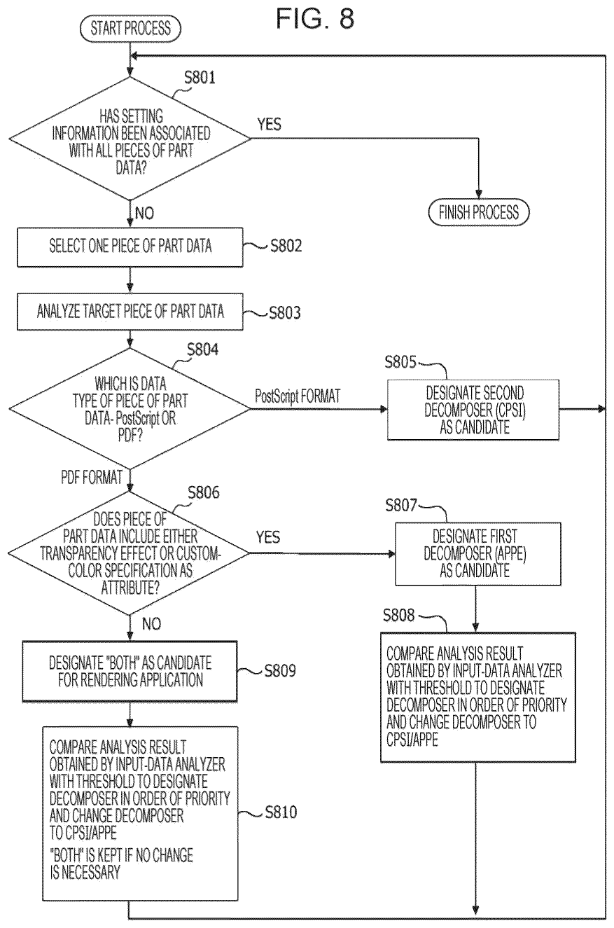

In the above exemplary embodiment, description has been given with regard to the case of selecting a candidate for the rendering application to perform a rendering process in accordance with the data type and the attribute of a piece of part data. In particular, in the above exemplary embodiment, as the setting information, the first decomposer 122, APPE, is selected as a candidate for the rendering application if an object included in the target piece of part data includes either the transparency effect or the custom-color specification. However, when a candidate for the rendering application is selected for a piece of part data, selection may be made based on a priority established in advance in accordance with the attribute of the piece of part data. In addition, a threshold may be established for each attribute included in a piece of part data, and a candidate for the rendering application may be selected based on a priority and a threshold established in advance in accordance with the attribute of the piece of part data. In Modification 1 below, referring to FIG. 7 and FIG. 8, description will be given with regard to a case of establishing a priority and a threshold for each attribute included in a piece of part data and redesignating a candidate for the rendering application based on the priority and the threshold.

FIG. 7 depicts an example of a threshold setting screen 700 for establishing a threshold to select a rendering application. The threshold setting screen 700 in FIG. 7 allows entry or selection of “Item”, which is the type of an attribute included in a piece of part data, “Priority” of the attribute, “Threshold” to be established for the attribute, and the type of a rendering application to be selected when the threshold is reached or exceeded for the attribute.

For example, in FIG. 7, for the attribute “Transparency Effect” included in a piece of part data, the priority is set to “1” and the threshold is set to “1”, leading to the selection of APPE as the rendering application in this case. This indicates that when a piece of part data includes one or more objects having the attribute “Transparency Effect”, APPE is selected as the rendering application to perform a rendering process with the priority equal to “1”, that is, with top priority.

Further, for example, for the attribute “Font” included in a piece of part data, the priority is set to “5”, and the names of the fonts are set to “Wingdings8” and “MRVDatamatrix6”, leading to the selection of CPSI as the rendering application in this case. This indicates that CPSI is selected as the rendering application to perform a rendering process for a piece of part data that includes the font “Wingdings8” or “MRVDatamatrix6” while including no attribute having the priority set to “1” to “4”.

In step S801 in FIG. 8, the input-data manager 116 determines whether setting information containing information regarding a candidate for the rendering application to perform a rendering process has been associated with all the multiple pieces of part data assigned the same job ID. If setting information has been associated with all the pieces of part data, the process ends, and a rendering-process setting screen similar to the one described in FIG. 6 is generated and displayed. If setting information has not been associated with one or more pieces of part data, the process proceeds to step S802.

In step S802, the input-data manager 116 selects one of the multiple pieces of part data contained in the print job, and the process proceeds to step S803 and later described below.

In step S803, the input-data analyzer 117 analyzes a target piece of part data selected in step S802 and extracts data information including information such as the data type, the page size, and the color space, the font, the presence of the transparency effect, and the presence of the custom-color specification.

In step S804, the part-data processing determiner 118 uses the analysis result obtained by the input-data analyzer 117 to determine the data type of the piece of part data. Specifically, if the data type of the piece of part data is the PostScript format, the process proceeds to step S805.

In step S805, the part-data processing determiner 118 selects the second decomposer 123 as a candidate for the rendering application to perform a rendering process for the target piece of part data. In Modification 1, the second decomposer 123 is CPSI, and this setting information is saved to the input-data storage 112 in association with the target piece of part data. Subsequently, the process returns to step S801.

If it is determined in step S804 that the data type of the piece of part data is the pdf format, the process proceeds to step S806.

In step S806, the part-data processing determiner 118 uses the analysis result obtained by the input-data analyzer 117 to determine the attribute of the piece of part data. Specifically, it is determined whether an object included in the target piece of part data includes either the transparency effect or the custom-color specification, and if the object includes either the transparency effect or the custom-color specification, the process proceeds to step S807.

In step S807, as the setting information, the part-data processing determiner 118 tentatively designates the first decomposer 122 as a candidate for the rendering application to perform a rendering process for the target piece of part data and saves the setting information to the input-data storage 112 in association with the target piece of part data. In Modification 1, the first decomposer 122 is APPE. Subsequently, the process proceeds to step S808.

In step S808, the part-data processing determiner 118 compares the analysis result obtained by the input-data analyzer 117 with a threshold to designate a rendering application in order of priority. If the comparison indicates that the target piece of part data includes a high-priority attribute for which the threshold to designate CPSI as the rendering application is exceeded, CPSI is saved to the input-data storage 112 as the rendering application in association with the target piece of part data. If the target piece of part data does not include a high-priority attribute for which the threshold to designate CPSI as the rendering application is exceeded, APPE is saved without a change to the input-data storage 112 as the rendering application in association with the target piece of part data. Subsequently, the process returns to step S801.

In one example, the priority of the attribute “Font” included in a piece of part data is set to “1”, and CPSI is designated as the rendering application to be selected when a specific font is included. Then, CPSI is selected as the rendering application to perform a rendering process even if the piece of part data includes an attribute, such as the transparency effect or the custom-color specification, assigned a priority set to “2” or a lower priority.

If it is determined in step S806 that no object included in the target piece of part data includes the transparency effect or the custom-color specification, the process proceeds to step S809.

In step S809, as the setting information, the part-data processing determiner 118 tentatively designates “BOTH” as a candidate for the rendering application to perform a rendering process for the target piece of part data and saves the setting information to the input-data storage 112 in association with the target piece of part data. Subsequently, the process proceeds to step S810.

In step S810, the part-data processing determiner 118 compares the analysis result obtained by the input-data analyzer 117 with a threshold to designate a rendering application in order of priority. If the comparison indicates that the target piece of part data includes a higher-priority attribute for which the threshold to designate APPE as the rendering application is exceeded, APPE is saved to the input-data storage 112 as the rendering application in association with the target piece of part data. In contrast, if the target piece of part data includes a higher-priority attribute for which the threshold to designate CPSI as the rendering application is exceeded, CPSI is saved to the input-data storage 112 as the rendering application in association with the target piece of part data. The setting “BOTH” is kept as a candidate for the rendering application if no change is necessary. Subsequently, the process returns to step S801.

In step S801, the input-data manager 116 determines whether a candidate for the rendering application has been associated with all the multiple pieces of part data, and upon determining that a candidate has been associated with all the multiple pieces of part data, the input-data manager 116 displays the rendering-process setting screen 600 similar to the one described in FIG. 6.

### Modification 2

In the above exemplary embodiment, description has been given with regard to an example in which the rendering-process setting screen 600 displays a candidate for the rendering application designated for a piece of part data contained in a print job and the user is allowed to redesignate a candidate for the rendering application. However, the present disclosure is not limited to the above exemplary embodiment, and as in Modification 2, the user may be allowed to select a rendering application to perform a rendering process after checking a rendered result of a piece of part data to confirm the rendered result in a rendering-process setting screen 900.

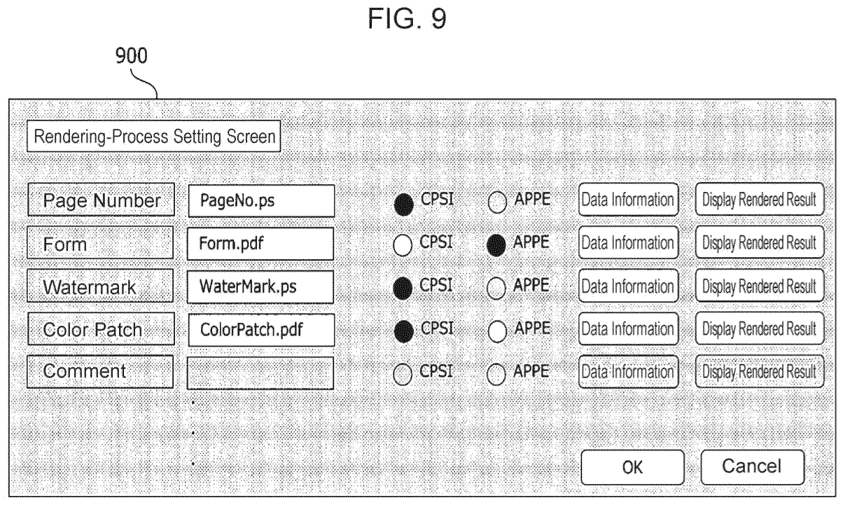

Specifically, the rendering-process setting screen 900 according to Modification 2 depicted in FIG. 9 further displays “Display Rendered Result” buttons in addition to each piece of part data in the rendering-process setting screen 600 according to the exemplary embodiment depicted in FIG. 6. Each of the “Display Rendered Result” buttons is disposed in conjunction with the corresponding piece of part data. Selecting one of the “Display Rendered Result” button corresponding to a specific piece of part data enables the user to check the rendered result of the specific piece of part data.

For example, the user selects a “Display Rendered Result” button corresponding to one piece of part data in the rendering-process setting screen 900 in FIG. 9. Then, the rendering controller 119 instructs the rendering controller for part data 121 to perform respective rendering processes for the piece of part data using the two rendering applications CPSI and APPE.

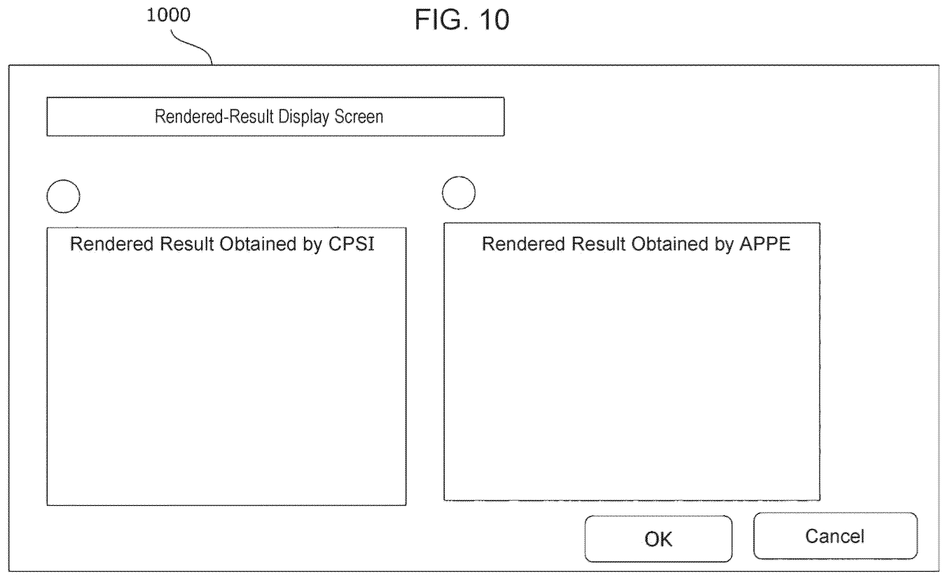

The rendering controller for part data 121 performs respective rendering processes for the selected piece of part data using the two rendering applications CPSI and APPE. The rendering processor 113 then creates a rendered-result display screen 1000 depicted in FIG. 10 and displays rendered results of the piece of part data obtained by respective rendering applications.

The rendered-result display screen 1000 depicted in FIG. 10 is a selection screen configured to, for each piece of part data, display a rendered result obtained by each rendering application to be designated as a candidate and ask the user to select a rendering application to be used. Specifically, as depicted in FIG. 10, the rendered-result display screen 1000 displays a rendered image of a piece of part data obtained through a rendering process by the rendering application CPSI and a rendered image of the piece of part data obtained through a rendering process by the rendering application APPE. In addition, a radio button is disposed for each rendered image of the piece of part data to allow the user to refer to the rendered image of the piece of part data and select which rendering application to use for the final rendering process.

In the rendered-result display screen 1000 in FIG. 10, in response to the “OK” button being selected while a rendering application to perform the rendering process is selected, the process returns to the rendering-process setting screen 900 in FIG. 9 with the rendering application selected in FIG. 10 being selected.

When the rendering-process setting screen 900 in FIG. 9 displays candidates for the rendering application in such a manner that the displayed rendering applications are selectable, respective rendered results obtained by the two rendering applications are displayed as described above. In contrast, when the rendering-process setting screen 900 in FIG. 9 displays candidates for the rendering application in such a manner that one of the displayed rendering application is unselectable, a rendering process is performed only by the rendering application selected in FIG. 9, and the result is displayed in the rendered-result display screen 1000.

For example, in FIG. 9, APPE is selected as a candidate for the rendering application for the piece of part data “Form”, and CPSI is also displayed as a candidate for the rendering application in the selectable condition. Thus, as depicted in FIG. 10, selecting the “Display Rendered Result” button causes the rendered-result display screen 1000 to display a rendered image of the piece of part data obtained through a rendering process by CPSI and a rendered image of the piece of part data obtained through a rendering process by the rendering application APPE.

If one of the two rendering applications is not able to perform a rendering process and causes an error, an error screen is displayed, and only a rendered result is displayed that is obtained through a rendering process successfully performed by a rendering application, which is the only selectable rendering application.

In contrast, in FIG. 9, while CPSI is selected as a candidate for the rendering application for the piece of part data “Watermark”, APPE is displayed with the radio button being unselectable. In this case, selecting the “Display Rendered Result” button causes the rendered-result display screen 1000 in FIG. 10 to display a rendered result of the piece of part data “Watermark” obtained through a rendering process only by the rendering application CPSI.

In response to the “OK” button being pushed in the rendering-process setting screen 900 in FIG. 9, as in the exemplary embodiment, a rendering process for the part data and a rendering process for the document data are individually performed, a composite image is formed to create final data, and print data is output to the printer 3 via the engine IF 106. For a piece of part data that has already been subjected to a rendering process during the rendered-result display, the rendered data of the piece of part data is used to create the final data by the composite output unit 115. A rendered result that has been obtained through a rendering process during the rendered-result display but that has not been selected is discarded when the final data is created.

### Modification 3

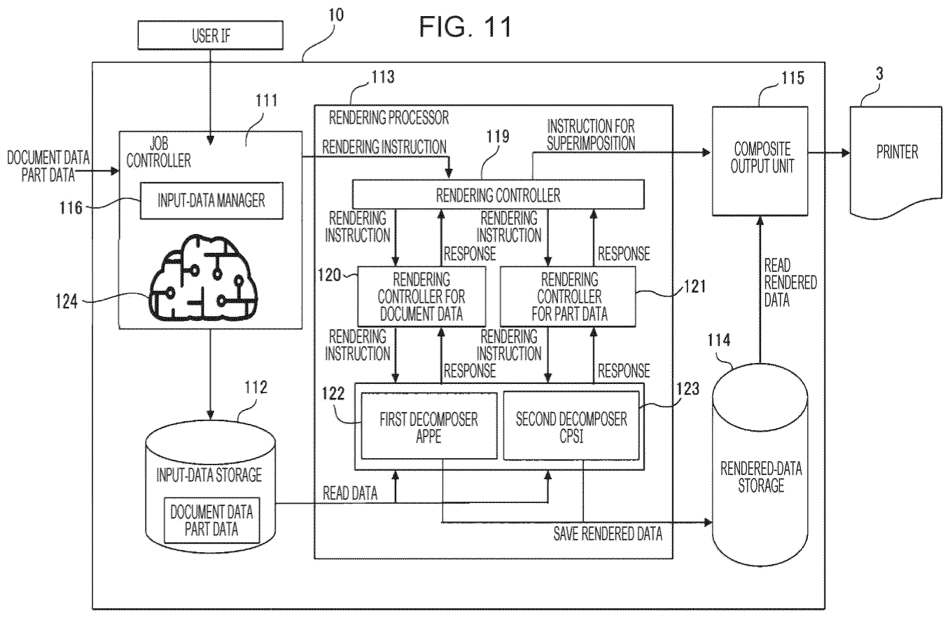

In the above exemplary embodiment, Modification 1, and Modification 2, the input-data analyzer 117 and the part-data processing determiner 118 are configured to select a candidate for the rendering application to perform a rendering process for a piece of part data in accordance with the attribute and the data type of the piece of part data. However, the present disclosure is not limited to the examples described above. As depicted in FIG. 11, a learning model 124 may have been constructed in advance through training using correlations between the data type and attribute of each piece of part data and a rendering application to perform a rendering process, and the learning model 124 may be prepared in advance in the job controller 111. Then, each piece of part data is entered into the learning model 124, and a candidate for the rendering application to perform a rendering process for the piece of part data may be selected based on a selection result that is output from the learning model 124.

In the above exemplary embodiment and Modification 1 to Modification 3, description has been given as examples with regard to the case of using APPE as the first decomposer 122, which is the first rendering application, and using CPSI as the second decomposer 123, which is the second rendering application. However, the present disclosure is not limited to the examples described above, and other rendering applications may be used.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An image processing system comprising:
a processor configured to:
   accept document data to be printed and a plurality of pieces of additional data each including a shared image to be used across a plurality of pages;
   for each piece of the plurality of pieces of additional data,
      select a corresponding rendering application in accordance with an attribute of the piece of the plurality of pieces of additional data;
      perform a rendering process using the selected rendering application; and
      generate image data to be used for image formation by superimposing data obtained through the rendering process onto data obtained through a rendering process for the document data to be printed.
         (((2)))

The image processing system according to (((1))),
wherein the processor is configured to select the corresponding rendering application for each piece of the plurality of pieces of additional data in accordance with a data type of the piece of the plurality of pieces of additional data.
   (((3)))

The image processing system according to (((2))),
wherein the processor is configured to, for each piece of the plurality of pieces of additional data, select a first rendering application if the piece of the plurality of pieces of additional data includes, as the attribute, either a transparency effect or a custom-color specification and select a second rendering application if the data type of the piece of the plurality of pieces of additional data is a specific page description language format.
   (((4)))

The image processing system according to (((3))),
wherein the processor is configured to, for each piece of the plurality of pieces of additional data, select a rendering application that has been selected for a larger number of pieces of the plurality of pieces of additional data if the piece of the plurality of pieces of additional data includes, as the attribute, neither the transparency effect nor the custom-color specification and the data type of the piece of the plurality of pieces of additional data is not the specific page description language format.
   (((5)))

The image processing system according to (((1))),
wherein the processor is configured to, for each piece of the plurality of pieces of additional data, select the corresponding rendering application based on a priority established in advance in accordance with the attribute of the piece of the plurality of pieces of additional data.
   (((6)))

The image processing system according to (((1))),
wherein the processor is configured to, when performing a rendering process using the rendering application for each piece of the plurality of pieces of additional data, consecutively perform rendering processes for pieces of additional data for which the same rendering application is used.
   (((7)))

The image processing system according to (((1))),

wherein the processor is configured to, for each piece of the plurality of pieces of additional data, generate and display a confirmation screen displaying a selected candidate for the rendering application to ask a user for confirmation.
(((8)))

The image processing system according to (((7))),
wherein the processor is configured to, for each piece of the plurality of pieces of additional data, display a result of a rendering process performed using the selected candidate for the rendering application and generate and display a selection screen to ask the user to select a rendering application to be used.
   (((9)))

The image processing system according to (((1))),
wherein the processor is configured to enter each piece of the plurality of pieces of additional data into a pre-trained learning model and select the corresponding rendering application configured to perform a rendering process for the piece of the plurality of pieces of additional data based on a selection result that is output from the pre-trained learning model.
   (((10)))

A program causing a computer to execute a process comprising:
accepting document data to be printed and a plurality of pieces of additional data each including a shared image to be used across a plurality of pages;
for each piece of the plurality of pieces of additional data,
   selecting a corresponding rendering application in accordance with an attribute of the piece of the plurality of pieces of additional data;
   performing a rendering process using the selected rendering application; and
   generating image data to be used for image formation by superimposing data obtained through the rendering process onto data obtained through a rendering process for the document data to be printed.

What is claimed is:

1. An image processing system comprising:
a processor configured to:
accept document data to be printed and a plurality of pieces of additional data each including a shared image to be used across a plurality of pages;
for each piece of the plurality of pieces of additional data,
select a corresponding rendering application in accordance with an attribute of the piece of the plurality of pieces of additional data;
perform a rendering process using the selected rendering application; and
generate image data to be used for image formation by superimposing data obtained through the rendering process onto data obtained through a rendering process for the document data to be printed.

2. The image processing system according to claim 1,
wherein the processor is configured to select the corresponding rendering application for each piece of the plurality of pieces of additional data in accordance with a data type of the piece of the plurality of pieces of additional data.

3. The image processing system according to claim 2,
wherein the processor is configured to, for each piece of the plurality of pieces of additional data, select a first rendering application if the piece of the plurality of pieces of additional data includes, as the attribute, either a transparency effect or a custom-color specification and select a second rendering application if the data type of the piece of the plurality of pieces of additional data is a specific page description language format.

4. The image processing system according to claim 3,
wherein the processor is configured to, for each piece of the plurality of pieces of additional data, select a rendering application that has been selected for a larger number of pieces of the plurality of pieces of additional data if the piece of the plurality of pieces of additional data includes, as the attribute, neither the transparency effect nor the custom-color specification and the data type of the piece of the plurality of pieces of additional data is not the specific page description language format.

5. The image processing system according to claim 1,
wherein the processor is configured to, for each piece of the plurality of pieces of additional data, select the corresponding rendering application based on a priority established in advance in accordance with the attribute of the piece of the plurality of pieces of additional data.

6. The image processing system according to claim 1,
wherein the processor is configured to, when performing a rendering process using the rendering application for each piece of the plurality of pieces of additional data, consecutively perform rendering processes for pieces of additional data for which the same rendering application is used.

7. The image processing system according to claim 1,
wherein the processor is configured to, for each piece of the plurality of pieces of additional data, generate and display a confirmation screen displaying a selected candidate for the rendering application to ask a user for confirmation.

8. The image processing system according to claim 7,
wherein the processor is configured to, for each piece of the plurality of pieces of additional data, display a result of a rendering process performed using the selected candidate for the rendering application and generate and display a selection screen to ask the user to select a rendering application to be used.

9. The image processing system according to claim 1,
wherein the processor is configured to enter each piece of the plurality of pieces of additional data into a pre-trained learning model and select the corresponding rendering application configured to perform a rendering process for the piece of the plurality of pieces of additional data based on a selection result that is output from the pre-trained learning model.

10. A non-transitory computer readable medium storing a program causing a computer to execute a process comprising:
accepting document data to be printed and a plurality of pieces of additional data each including a shared image to be used across a plurality of pages;
for each piece of the plurality of pieces of additional data,
selecting a corresponding rendering application in accordance with an attribute of the piece of the plurality of pieces of additional data;
performing a rendering process using the selected rendering application; and
generating image data to be used for image formation by superimposing data obtained through the rendering process onto data obtained through a rendering process for the document data to be printed.

11. An image processing method comprising:
accepting document data to be printed and a plurality of pieces of additional data each including a shared image to be used across a plurality of pages;
for each piece of the plurality of pieces of additional data,
selecting a corresponding rendering application in accordance with an attribute of the piece of the plurality of pieces of additional data;
performing a rendering process using the selected rendering application; and
generating image data to be used for image formation by superimposing data obtained through the rendering process onto data obtained through a rendering process for the document data to be printed.
